(19) United States
(12) Patent Application Publication
(10) Pub. No.: US 2015/0369069 A1
(43) Pub. Date: Dec. 24, 2015

(54) STATOR BODY CENTERING FEATURE FOR TORQUE CONVERTER

(71) Applicant: Schaeffler Technologies AG & Co. KG, Herzogenaurach (DE)

(72) Inventors: Matthew Smith, Wooster, OH (US); Daniel Sayre, Copley, OH (US)

(73) Assignee: Schaeffler Technologies AG & Co. KG, Herzogenaurach (DE)

(21) Appl. No.: 14/723,581

(22) Filed: May 28, 2015

Related U.S. Application Data
(60) Provisional application No. 62/016,216, filed on Jun. 24, 2014.

(51) Int. Cl. F01D 9/04; F16H 45/02; F01D 25/24; F16H 41/04; F01D 5/02; F01D 5/12

(52) U.S. Cl. CPC F01D 9/041; F01D 5/02; F01D 5/12; F01D 25/24; F16H 41/04; F16H 45/02; F05D 2240/14

(57) ABSTRACT

A stator for a torque converter comprising: (i) an axis of rotation; (ii) a body portion including: a first body circumference; a back wall; at least one centering protrusion extending to a first measured axial distance relative to the back wall; and a second body circumference; (iii) a blade portion including: an outer circumference; and a plurality of blades, arranged for directing fluid flow, extending in a radial direction from the second body circumference to the outer circumference; and (iv) a housing portion, disposed radially inward relative to the body portion, including: a radial wall, disposed at a second measured axial distance relative to the back wall, having a thrust surface; and, wherein the housing portion is arranged for housing a one-way clutch; and, wherein the first axial distance is greater than the second axial distance.

### FIELD

The invention relates generally to a stator in a torque converter, and more specifically to a stator having at least one centering feature, which mates complementarily with the turbine shell, to position the stator during assembly.

### BACKGROUND

Co-pending U.S. Provisional Patent Application No. 61/899,325, hereby incorporated by reference herein, describes a torque converter, and shows a core ring featuring tabs or lances to center the stator.

U.S. Pat. No. 8,573,374, hereby incorporated by reference herein, discloses a method for centering a hub flange for a torque converter, wherein the stator inner race is centered on the pump hub inner diameter.

U.S. Patent Application Publication No. 2012/0266589, hereby incorporated by reference herein, discloses a torque converter cross-section including a turbine including at least one blade and a shell, wherein the shell includes a portion disposed radially inward of the at least one blade.

To install a torque converter into a transmission it is known to align and then engage an input shaft, stator shaft, and pump gear for the transmission to a turbine hub, stator hub, and impeller hub, respectively, for the torque converter. This process can be difficult and time consuming because of the large number of shafts and hubs that must be properly aligned. If the input shaft, stator shaft, or pump gear and the turbine hub, stator hub, or impeller hub are not properly aligned, it is known to rotate one or more of the misaligned elements with respect to each other and then attempt to engage the an input shaft, stator shaft, pump gear, a turbine hub, stator hub, and impeller hub. Torque converter design must hence incorporate features that allow the components to align to enable quick assembly.

### BRIEF SUMMARY

Example aspects broadly comprise a stator for a torque converter comprising: (i) an axis of rotation; (ii) a body portion including: a first body circumference; a back wall; at least one centering protrusion extending to a first measured axial distance relative to the back wall; and a second body circumference; (iii) a blade portion including: an outer circumference; and a plurality of blades, arranged for directing fluid flow, extending in a radial direction from the second body circumference to the outer circumference; and (iv) a housing portion, arranged for housing a one-way clutch and disposed radially inward relative to the body portion, including: a radial wall, disposed at a second measured axial distance relative to the back wall, having a thrust surface. In an example aspect, the first axial distance is greater than the second axial distance.

In an example aspect, the at least one centering protrusion is for maintaining concentricity relative to the axis of rotation and for limiting displacement of the stator within a turbine shell. In an example aspect, the body portion further includes a front wall extending to a third measured axial distance relative to the back wall. In an example aspect, the first measured axial distance is greater than the third measured axial distance. In an example aspect, the second measured axial distance is same or equal to the third measured axial distance. In other example aspects, the second measured axial distance is greater than the third measured axial distance. In an example aspect, the at least one centering protrusion is annular. In other example aspects, the at least one centering protrusion is a plurality of castles, which may be cylindrical, cuboid, or frustum shaped. In an example aspect, the at least one centering protrusion includes a first surface, a second surface, and a third surface; wherein the third surface connects the first and second surfaces. In an example aspect, the third surface is rounded, flat, or pointed. In an example aspect, the at least one centering protrusion is arranged to fit complementarily within an inner periphery portion of the turbine shell.

Other example aspects broadly comprise a torque converter comprising: the stator vide supra, wherein the centering protrusion extends in a first axial direction; and, a turbine having a plurality of blades and a shell, the shell including: an inner surface; an outer surface; a curved portion including a recess and an apex, opposite the recess, where the apex protrudes toward the stator in a second axial direction, opposite the first axial direction; and an inner periphery portion, disposed radially inward from the curved portion, including an inner periphery surface. In an example aspect, the plurality of turbine blades are disposed radially outward relative to the apex.

In an example aspect, the turbine's curved portion limits axial and radial displacement of the stator's centering protrusion. In an example aspect, the at least one centering protrusion is for maintaining concentricity relative to the axis of rotation and for limiting displacement of the stator within the turbine shell. In an example aspect, the at least one centering protrusion is annular. In other example aspects, the at least one centering protrusion is a plurality of castles. In an example aspect, the castles are cylindrical, cuboid, or frustum shaped. In an example aspect, the at least one centering protrusion is arranged to fit complementarily within the inner periphery portion of the turbine shell.

Other example aspects broadly comprise a torque converter comprising: an axis of rotation; a stator, having a plurality of blades arranged for directing fluid flow, and including: a body portion including at least one centering protrusion extending in a first axial direction; and a housing portion, disposed radially inward relative to the body portion; a turbine, having a plurality of blades and a shell, the shell including: a curved portion, disposed radially outward relative to the centering protrusion, and including a recess and an apex, opposite the recess, where the apex protrudes toward the stator in a second axial direction, opposite the first axial direction; an inner periphery portion, disposed radially inward from the curved portion, wherein the at least one centering protrusion is arranged to fit complementarily within the inner periphery portion; and, wherein a line, oriented in a direction perpendicular to the axis of rotation, lies on both the centering protrusion and the curved portion; and wherein the line does not lie on the housing portion.

### BRIEF DESCRIPTION OF THE DRAWINGS

The nature and mode of operation of the present invention will now be more fully described in the following detailed description of the invention taken with the accompanying drawing figures, in which:

FIG. 1 illustrates a torque converter according to the prior art.

FIG. 2 illustrates a cross-sectional view of a torque converter including a centering protrusion according to an example aspect.

FIG. 3 illustrates a partial cross-sectional view of a torque converter including a centering protrusion according to an example aspect.

FIG. 4 illustrates cross-sectional view of a stator including a centering protrusion according to an example aspect.

### DETAILED DESCRIPTION

At the outset, it should be appreciated that like drawing numbers appearing in different drawing views identify identical, or functionally similar, structural elements.

Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

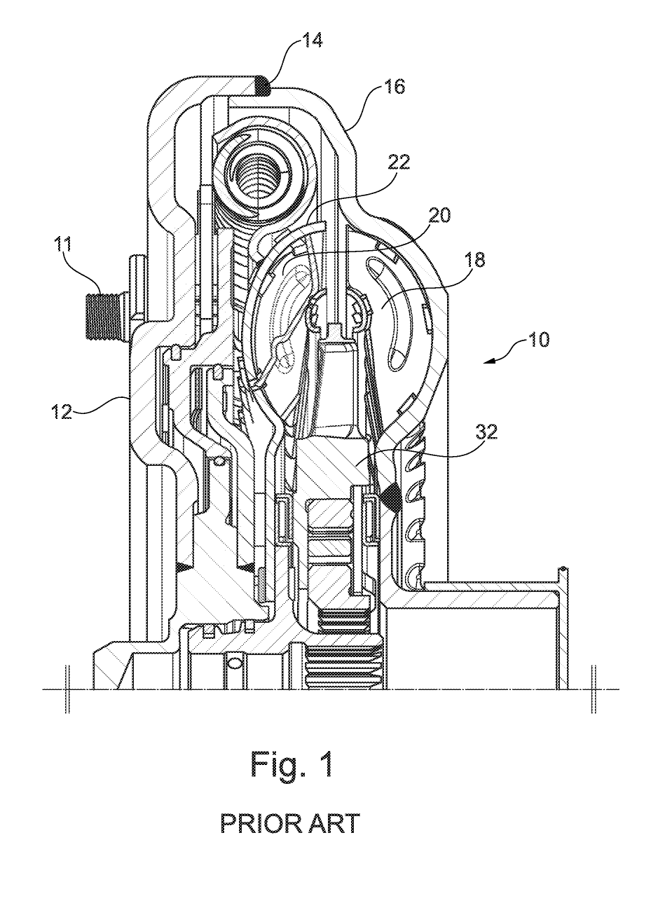

The following description is made with reference to FIG. 1. FIG. 1 shows in cross section torque converter 10 of the prior art illustrating a front cover 12 for connecting to a crankshaft of an internal combustion engine via stud 11, and rear cover 16. Torque converter 10 also includes impeller 18, turbine 20, turbine shell 22 and stator 32 between turbine 20 and impeller 18. Turbines and impellers, as is known in the art, include a plurality of blades. Assembly and installation of a prior art torque converter as shown in FIG. 1 is made difficult due to axial and radial movement of the stator within the torque converter. Misalignment of the stator results in negative performance issues and reduced wear.

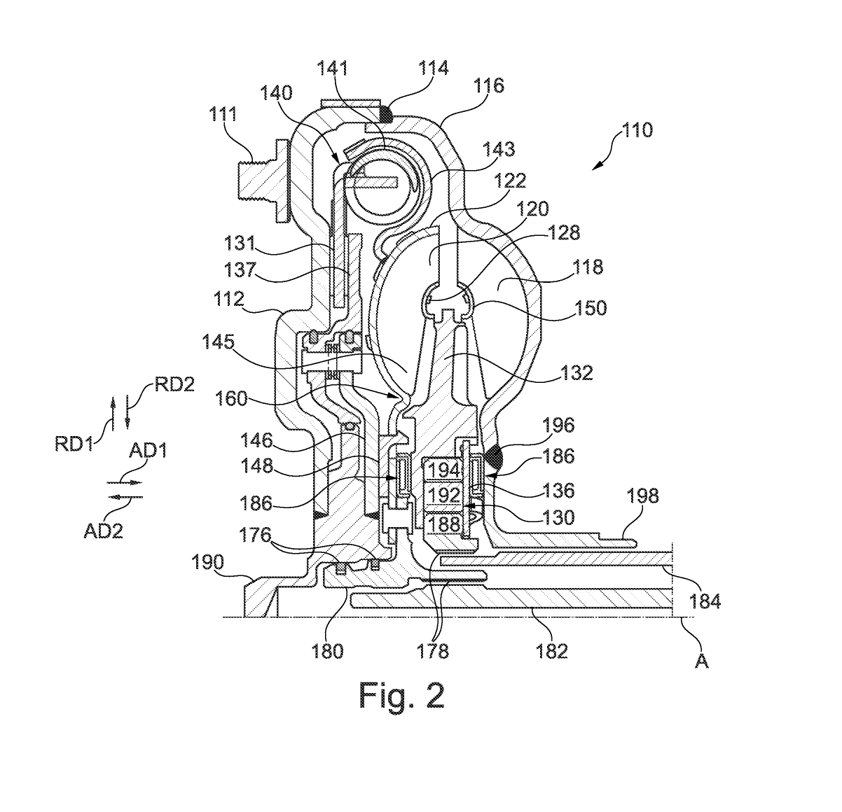

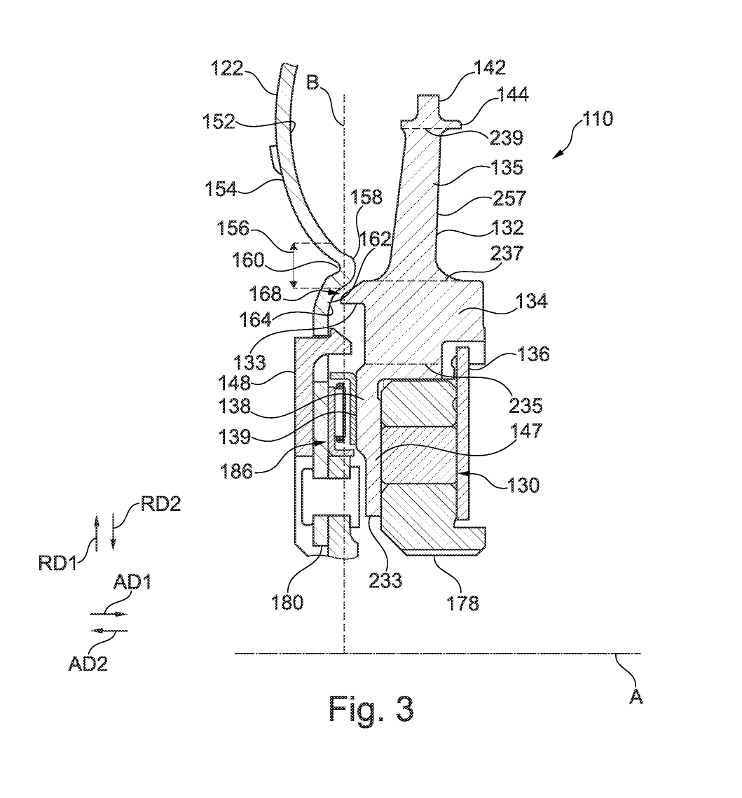

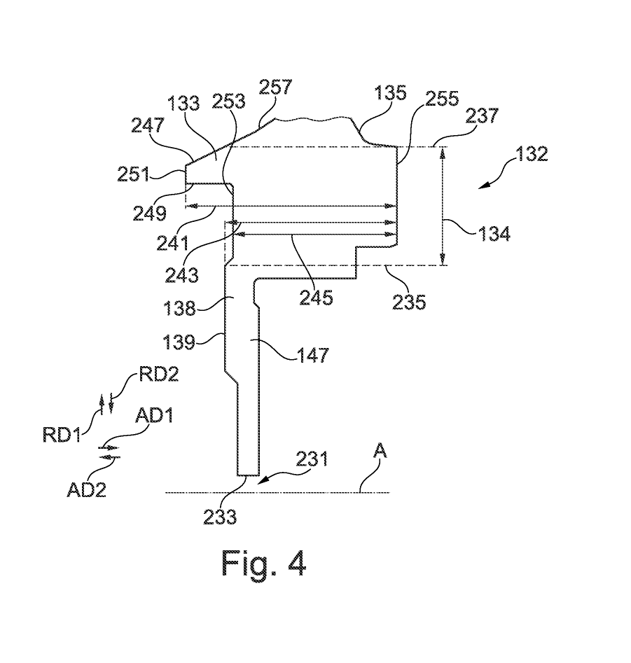

The following description is made with reference to FIGS. 2-4. FIG. 2 shows a partial cross section of torque converter 110 in an example aspect. Torque converter 110 includes front cover 112 for connecting to a crankshaft of an internal combustion engine via stud 111 and rear cover 116, also referred to as impeller shell interchangeably herein, for an impeller 118. Impellers are also referred to in the art interchangeably as ‘pump’. Front cover 112 and rear cover 116 are fastened together via weld 114. Cover 112 includes cover pilot portion 190. Torque converter 110 also includes turbine 120, turbine shell 122, stator 132 between turbine 120 and impeller 118. Turbines and impellers, as is known in the art, include a plurality of blades. Turbine blades 124 have tabs 128 extending through slots in core ring 150. Blades are joined after assembly by bending, and fixed to core ring 150 by brazing or welding or by other methods known to those skilled in the art. Core ring 150 extends circumferentially about axis of rotation A, also referred to as simply axis A. Stator 132 will be described in greater detail as relates to FIGS. 3-4. Generally, first axial direction AD1 is opposite to second axial direction AD2; and, first radial direction RD1 is opposite to second radial direction RD2.

Referring again to FIG. 2, Torque converter 110 further includes one-way clutch 130, which supports stator 132, and includes inner race 188, roller 192, and outer race 194. Side plate 136 holds one-way clutch 130 in place within stator 132. Stator 132 includes a groove to accommodate side plate 136. Torque converter 110 also includes damper assembly 140, which is connected to and drivable by turbine 120, and is positioned between turbine 120 and front cover 112. Damper assembly 140 includes clutch plate 131, spring 141, and spring retainer 143 fixed to turbine shell 122. Clutch plate 131 is connected to piston plate 137. Thrust washer 148 is disposed between turbine shell 122 and flange 146.

Torque converter 110 includes hub 180 fixed to turbine shell 122 and flange 146 via thrust washer 148, bearings 186 including cages, seals 176, weld 196, and hub 198. FIG. 2 also shows transmission components including splines 178, input shaft 182, and stator shaft 184. Hub 180 is splined to input shaft 182 and inner race 188 is splined to stator shaft 184 at at splines 178. Seals 176 at least partially seal hub 180 to front cover 112.

Referring to FIG. 3 showing a partial view of a torque converter according to an example aspect, torque converter 110 includes turbine shell 122 and stator 132. Turbine shell 122 includes inner surface 152, outer surface 154, and curved portion 156. Curved portion 156 includes apex 158 and recess 160, which is opposite to apex 158. Apex 158 defines the tip or inflection point of curved portion 156 most axially disposed in first axial direction AD 1. Turbine shell 122 further includes inner periphery portion 162 Inner periphery portion 162 is a generally radial wall portion of turbine shell 122 disposed radially inward from curved portion 156. Inner periphery portion 162 includes inner periphery surface 164. Axial and radial displacement of stator 132 is limited by centering protrusion 133 of stator 132. Clearance 168 is the distance between centering protrusion 133 and inner periphery surface 164. During assembly and installation, some contact between centering protrusion 133 and inner periphery surface 164 may occur; however, as one skilled in the art would recognize, there is preferably clearance between centering protrusion 133 and inner periphery surface 164 during torque converter operation. Centering protrusion 133 does not impinge or stay in contact with inner periphery surface 164 at one or more locations during torque converter operation.

Stator 132 may be made by any methods known in the art; in an example aspect, the stator is cast aluminum. Alternatively, a phenolic stator is used. Stator 132 includes stator body portion 134, blade portion 135, and housing portion 147. Blade portion 135 includes a plurality of blades 257. Blades 257 are arranged, in a radial direction extending from second body circumference 237 to outer circumference 239, for directing fluid flow. Optionally, stator blade portion 135 includes stator hat 142 and stator rim 144. Stator hat 142 typically represents the top portion of a stator and the stator rim 144 is the horizontal region just below the hat.

Stator body portion 134 includes first body circumference 235, second body circumference 237, and at least one element 133 for centering. The at least one element for centering or positioning a stator is interchangeably referred to herein as centering protrusion, centering element, or positioning element. The at least one centering protrusion 133 extends in second axial direction AD2, opposite to first axial direction AD1. Centering protrusion 133 does not interfere with the operational function of torque converter 110. Centering protrusion 133 is annular or ring-shaped in an example aspect. In another example aspect, centering protrusion 133 is a plurality of protrusions circumferentially disposed and evenly spaced apart. The protrusions are interchangeably referred to herein as castles. Prior to assembly, torque converter components including turbine components have internal freedom of movement. The at least one centering protrusion 133 advantageously aligns stator 132 during assembly by centering the stator with respect to the turbine shell.

Stator 132 includes housing portion 147 arranged for housing one-way clutch 130. Housing portion 147 includes radial wall 138 having thrust surface 139. Line B represents a line, oriented in a direction perpendicular to axis of rotation A, that lies on both centering protrusion 133 of stator 132 and curved portion 156 of turbine shell 122; and wherein the line does not lie on housing portion 147.

Referring to FIGS. 2 and 3, in an example aspect, torque converter 110 comprises stator 132, including at least one centering protrusion 133 extending in axial direction AD2, and turbine 120 having a plurality of blades 145 and shell 122. Shell 122 includes inner surface 152, outer surface 154, and curved portion 156 including recess 160 and apex 158, which is opposite recess 160. Apex 158 protrudes toward stator 132 in axial direction AD1, opposite axial direction AD2. Turbine shell 122 includes inner periphery portion 162, disposed radially inward from curved portion 156, including inner periphery surface 164. The plurality of turbine blades 145 are disposed radially outward relative to apex 158. In an example aspect, curved portion 156 limits axial and radial displacement of centering protrusion 133 during assembly and installation. In an example aspect, the at least one centering protrusion 133 is for maintaining concentricity relative to axis of rotation A and for limiting displacement of stator 132 within turbine shell 122. In an example aspect, the at least one centering protrusion 133 is arranged to fit complementarily within inner periphery portion 162 of turbine shell 122. In an example aspect, the at least one centering protrusion 133 is annular or ring-shaped. In an example embodiment, the at least one centering protrusion 133 is a plurality of castles; wherein castles may be cylindrical, cuboid, frustum shaped, or other non-limiting shapes as those skilled in the art would recognize.

Referring again to FIGS. 2 and 3, in another example aspect, torque converter 110 comprises axis of rotation A, stator 132, and turbine 120. Stator 132 includes a plurality of blades 257 arranged for directing fluid flow within stator 132 and further includes body portion 134 having at least one centering protrusion 133 extending in axial direction AD2 and housing portion 147, disposed radially inward relative to the body portion. Turbine 120, having a plurality of blades 145 and shell 122, where shell 122 includes curved portion 156, disposed radially outward relative to centering protrusion 133, recess 160, and apex 158. Apex 158 is opposite recess 160 and protrudes toward stator 132 in axial direction AD1, opposite axial direction AD2. Turbine shell 122 includes inner periphery portion 162, disposed radially inward from curved portion 156, wherein the at least one centering protrusion 133 is arranged to fit complementarily within inner periphery portion 162. Line B, oriented in a direction perpendicular to axis of rotation A, lies on both centering protrusion 133 and curved portion 156; line B does not lie on housing portion 147 of stator 132.

Referring to FIGS. 2 through 4, stator 132 for a torque converter comprises axis of rotation A and body portion 134 including first body circumference 235, second body circumference 237, front wall 253, back wall 255, and at least one centering protrusion 133 extending to a measured axial distance 241 relative to back wall 255. ‘Measured axial distances’ are also referred to as simply ‘axial distances’ interchangeably herein. Body portion 134 further includes front wall 253 extending to measured axial distance 245 relative to back wall 255. Axial distance 241 is greater than axial distance 245.

Stator 132 includes blade portion 135 disposed radially outward relative to body portion 134. Blade portion 135 includes a plurality of blades 257, arranged for directing fluid flow within the stator, extending in radial direction RD1 from second body circumference 237 to outer circumference 239 (refer to FIG. 3). Stator 132 further includes housing portion 147 disposed radially inward relative to body portion 134. Housing portion 147 includes radial wall 138, having thrust surface 139, housing inner circumference 233, and aperture 231, wherein aperture or hole 231 is concentric with housing inner circumference 233. ‘Housing inner circumference’ 233 is also referred to simply as ‘inner circumference’. Radial wall 138 is disposed at measured axial distance 243 relative to back wall 255. In an example aspect, axial distance 241 is greater than axial distance 243. In other words, centering protrusion 133 extends in axial direction AD2 to a distance greater does any part of housing portion 147, more specifically thrust surface 139 of radial wall 138. In an example aspect, measured axial distance 243 is same or equal to measured axial distance 245. In other example aspects, measured axial distance 243 is greater than measured axial distance 245. Housing portion 147 is arranged for housing one-way clutch 130. In an example aspect, the at least one centering protrusion 133 is for maintaining concentricity relative to axis of rotation A and for limiting displacement of stator 132 within turbine shell 122.

In an example aspect, the at least one centering protrusion 133 is annular or ring-shaped. In an example embodiment, centering protrusion 133 is a plurality of castles; castles may be cylindrical, cuboid, frustum shaped, or other non-limiting shapes as those skilled in the art would recognize. Referring again to FIG. 4, centering protrusion 133 includes first surface 247, second surface 249, and third surface or edge 251; wherein third surface 251 connects surfaces 247 and 249. Edge 251 may be rounded, flat, pointed or other configuration and is not limited herein. In example aspects, centering protrusion 133 is cylindrical, cuboid, frustum shaped, or other such shape as is arranged to fits complementarily within inner periphery surface 164 of turbine shell 122. In an example aspect, centering protrusion 133 has a complementary shape and/or contour so as to imitate or otherwise mirror the turbine shell inner surface, particularly inner periphery portion 162 having inner periphery surface 164, while maintaining clearance 168 during torque converter operation.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A stator for a torque converter comprising:
an axis of rotation;
a body portion including:
a first body circumference;
a back wall;
at least one centering protrusion extending to a first measured axial distance relative to the back wall; and
a second body circumference;
a blade portion including:
an outer circumference; and
a plurality of blades, arranged for directing fluid flow, extending in a radial direction from the second body circumference to the outer circumference;
a housing portion, disposed radially inward relative to the body portion, including:
a radial wall, disposed at a second measured axial distance relative to the back wall, having a thrust surface; and,
wherein the housing portion is arranged for housing a one-way clutch; and,
wherein the first axial distance is greater than the second axial distance.

2. The stator as in claim 1, wherein the at least one centering protrusion is for maintaining concentricity relative to the axis of rotation and for limiting displacement of the stator within a turbine shell.

3. The stator as in claim 1, wherein the body portion further includes a front wall extending to a third measured axial distance relative to the back wall.

4. The stator as in claim 3, wherein the first measured axial distance is greater than the third measured axial distance.

5. The stator as in claim 3, wherein the second measured axial distance is same or equal to the third measured axial distance.

6. The stator as in claim 3, wherein the second measured axial distance is greater than the third measured axial distance.

7. The stator as in claim 1, wherein the at least one centering protrusion is annular.

8. The stator as in claim 1, wherein the at least one centering protrusion is a plurality of castles.

9. The stator as in claim 8, wherein the castles are cylindrical, cuboid, or frustum shaped.

10. The stator as in claim 1, wherein the at least one centering protrusion includes a first surface, a second surface, and a third surface; wherein the third surface connects the first and second surfaces.

11. The stator as in claim 10, wherein the third surface is rounded, flat, or pointed.

12. The stator as in claim 2, wherein the at least one centering protrusion is arranged to fit complementarily within an inner periphery portion of the turbine shell.

13. A torque converter comprising:
the stator of claim 1, wherein the centering protrusion extends in a first axial direction; and,
a turbine having a plurality of blades and a shell, the shell including:
an inner surface;
an outer surface;
a curved portion including a recess and an apex, opposite the recess, where the apex protrudes toward the stator in a second axial direction, opposite the first axial direction; and
an inner periphery portion, disposed radially inward from the curved portion, including an inner periphery surface; and,
wherein the plurality of turbine blades are disposed radially outward relative to the apex.

14. The torque converter as in claim 13, wherein the curved portion limits axial and radial displacement of the centering protrusion.

15. The torque converter as in claim 13, wherein the at least one centering protrusion is for maintaining concentricity relative to the axis of rotation and for limiting displacement of the stator within the turbine shell.

16. The torque converter as in claim 13, wherein the at least one centering protrusion is annular.

17. The torque converter as in claim 13, wherein the at least one centering protrusion is a plurality of castles.

18. The torque converter as in claim 17, wherein the castles are cylindrical, cuboid, or frustum shaped.

19. The torque converter as in claim 13, wherein the at least one centering protrusion is arranged to fit complementarily within the inner periphery portion of the turbine shell.

20. A torque converter comprising:
an axis of rotation;
a stator, having a plurality of blades arranged for directing fluid flow, and including:
a body portion including at least one centering protrusion extending in a first axial direction; and
a housing portion, disposed radially inward relative to the body portion;
a turbine, having a plurality of blades and a shell, the shell including:
a curved portion, disposed radially outward relative to the centering protrusion, and including a recess and an apex, opposite the recess, where the apex protrudes toward the stator in a second axial direction, opposite the first axial direction;
an inner periphery portion, disposed radially inward from the curved portion, wherein the at least one centering protrusion is arranged to fit complementarily within the inner periphery portion; and,
wherein a line, oriented in a direction perpendicular to the axis of rotation, lies on both the centering protrusion and the curved portion; and wherein the line does not lie on the housing portion.
